(19) United States
(12) Patent Application Publication
(10) Pub. No.: US 2025/0035094 A1
(43) Pub. Date: Jan. 30, 2025

(54) PROPULSION APPARATUS

(71) Applicant: NIPPON TELEGRAPH AND TELEPHONE CORPORATION, Tokyo (JP)

(72) Inventor: Takanori WASHIRO, Tokyo (JP)

(21) Appl. No.: 18/716,683

(22) PCT Filed: Dec. 27, 2021
(86) PCT No.: PCT/JP2021/048593

§ 371 Date: Jun. 5, 2024

(51) Int. Cl. F03H 1/00; B64G 1/40

(52) U.S. Cl. CPC F03H 1/0037; B64G 1/413

(57) ABSTRACT

A propulsion apparatus includes: first and second conducting wires fixed with an interval therebetween; and a power supply configured to output an alternating current. The alternating current output from the power supply having a phase difference of 90 degrees is made to flow through the first and second conducting wires.

### TECHNICAL FIELD

The present invention relates to a technique for providing a propulsive force to a spacecraft in space.

### BACKGROUND ART

As techniques of the related art for performing acceleration, deceleration, and changing direction of spacecraft in space, there are a method (1) using a reaction caused by injection of a propellant, and a method (2) in which a momentum and kinetic energy are exchanged between a celestial body and a spacecraft using gravity when passing behind or in front of a celestial body (flying by), and respective motion vectors are changed between before and after the passing.

Specific examples of the method using the reaction of (1) include a rocket engine, an ion engine, and thrusters. Specific examples of the method (2) include swingby.

### CITATION LIST

### Non Patent Literature

Non Patent Literature 1: Transistor Technology, January 2019, https://www.cqpub.co.jp/toragi/2008-2020/Portals/0/backnumber/2019/01/p050.pdf

### SUMMARY OF INVENTION

### Technical Problem

For the method (1), in space where a propellant cannot be replenished, acceleration, deceleration, and changing of direction cannot be performed if the propellant loaded in the spacecraft in advance is used up. If a large amount of propellant is loaded, other necessary cargo may not be able to be loaded accordingly, and therefore, the amount of propellant which is loaded needs to be reduced as much as possible.

For the method (2), in the swingby using a suitable motion of heavenly bodies, the celestial body that meets the conditions for use does not always exist. Therefore, available places and times are limited. In order to change to a scheduled orbit using the swingby, considerable accuracy is required for orbit adjustment before entering a gravitational sphere of the celestial body. Therefore, control in which fuel is used is required to adjust the orbit. Also, it is necessary to pay attention to other conditions such as not changing the direction of an antenna for communicating with the Earth.

The present invention has been devised in view of the foregoing circumstances and an object of the present invention is to provide a technique for obtaining a propulsive force for a spacecraft without using a propellant and without interacting with the outside.

### Solution to Problem

According to the disclosed technology, there is provided a propulsion device (propulsion apparatus) including:
first and second conducting wires fixed with an interval therebetween; and
a power supply configured to output an alternating current.

The alternating currents output from the power supply having a phase difference of 90 degrees is made to flow through the first and second conducting wires.

### Advantageous Effects of Invention

According to the disclosed technology, there is provided a technology for obtaining a propulsive force of a spacecraft without using a propellant and without interacting with the outside.

### BRIEF DESCRIPTION OF DRAWINGS

FIG. 1 is a diagram illustrating a configuration of a spacecraft.

FIG. 2 is a diagram illustrating an operation principle of a propulsion device.

FIG. 3 is a diagram illustrating an operation principle of the propulsion device.

FIG. 4 is a diagram illustrating an operation principle of the propulsion device.

FIG. 5 is a diagram illustrating an operation principle of the propulsion device.

FIG. 6 is a diagram illustrating an operation principle of the propulsion device.

FIG. 7 is a diagram illustrating a first configuration example of a propulsion device.

FIG. 8 is a diagram illustrating a second configuration example of the propulsion device.

FIG. 9 is a diagram illustrating an example of a coil.

FIG. 10 is a diagram illustrating an example of a coil.

FIG. 11 is a diagram illustrating an example of a coil.

FIG. 12 is a diagram illustrating an operation principle using a coil.

FIG. 13 is a diagram illustrating an operation principle using a coil.

FIG. 14 is a diagram illustrating an operation principle using a coil.

FIG. 15 is a view illustrating an example of a coil including a magnetic core.

FIG. 16 is a diagram illustrating a third configuration example of the propulsion device.

FIG. 17 is a diagram illustrating a fourth configuration example of the propulsion device.

### DESCRIPTION OF EMBODIMENTS

An embodiment of the present invention (the present embodiment) will be described below with reference to the drawings. The embodiment to be described below is merely exemplary, and embodiments to which the present invention is applied are not limited to the embodiment to be described below.

In the present embodiment, a propulsion device 100 (propulsion apparatus) that obtains a propulsive force capable of performing acceleration, deceleration, and changing of a direction by high-frequency power without using a propellant and without interacting with the outside of a spacecraft will be described.

In the present embodiment, it is assumed that the propulsion device 100 is used for a spacecraft, but an application of the propulsion device 100 is not limited thereto. For example, the propulsion device 100 may be used as a power supply of a vehicle on the ground, a ship, or the like.

### (Overall Configuration and Operation Principle)

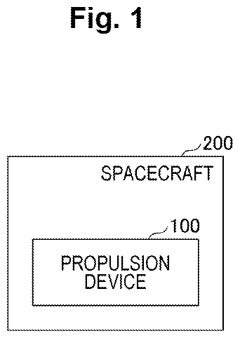

FIG. 1 illustrates a configuration of a spacecraft 200 according to the present embodiment. As illustrated in FIG. 1, the spacecraft 200 includes a propulsion device 100. An operation principle of the propulsion device 100 will be described below.

When a current flows through a conducting wire, a magnetic field is generated around the conducting wire (Ampere's law). When a current flows in a magnetic field, a force acts in a direction perpendicular to both the current and the magnetic field (Lorentz force). As a result, when a steady current flows through two parallel conducting wires, a conducting wire receives a force by a current flowing through the other conducting wire due to a magnetic field generated by one conducting wire.

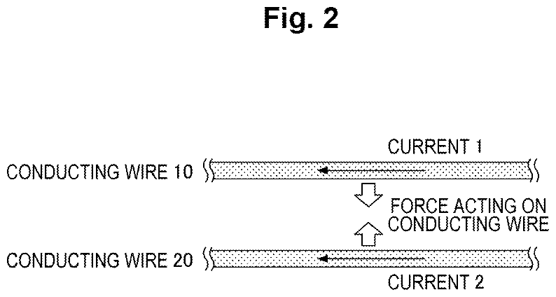

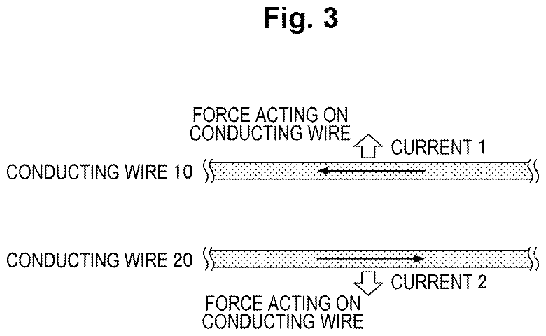

An example of the foregoing force will be described with reference to FIGS. 2 and 3. FIG. 2 illustrates a case where directions of current 1 and current 2 flowing through conducting wires 10 and 20 are the same. In this case, the conducting wires attract each other.

FIG. 3 illustrates a case where directions of current 1 and current 2 flowing through the conducting wires 10 and 20 are opposite to each other. In this case, the conducting wires repel each other.

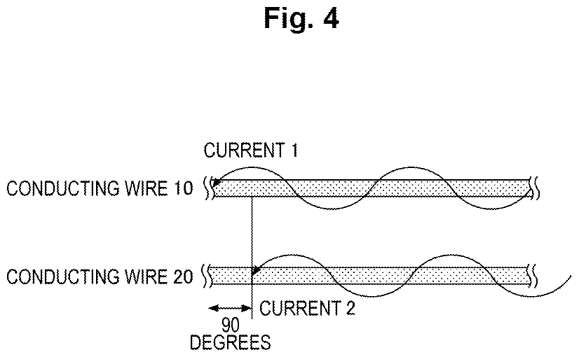

Next, it is considered that a high-frequency current in which the direction of a current periodically changes is caused to flow through a conducting wire instead of a steady current. As illustrated in FIG. 4, it is assumed that a high-frequency current is caused to flow through the two conducting wires 10 and 20 fixed with an interval therebetween, and a current flows through one conducting wire with a phase delayed by 90 degrees (that is, delayed by ¼ cycle) with respect to the other conducting wire. That is, as illustrated in FIG. 4, the phase of current 2 is delayed by 90 degrees from the phase of current 1.

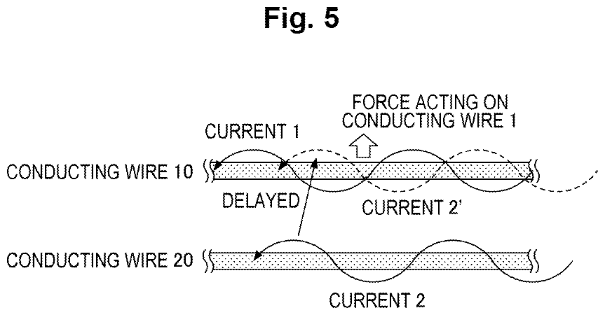

At this time, the direction of a force acting on the conducting wire 10 is considered. A magnetic field generated by the current flowing through the conducting wire 20 has a time delay while propagating the distance between the conducting wires 10 and 20. Therefore, as illustrated in FIG. 5, a state in which directions of the currents flowing through the two conducting wires become opposite to each other is achieved. When the direction of the currents flowing through the two conducting wires are opposite, a direction of a force acting on the conducting wires is a repulsion direction. Therefore, an upward force is generated in the conducting wire 10 as illustrated in FIG. 5.

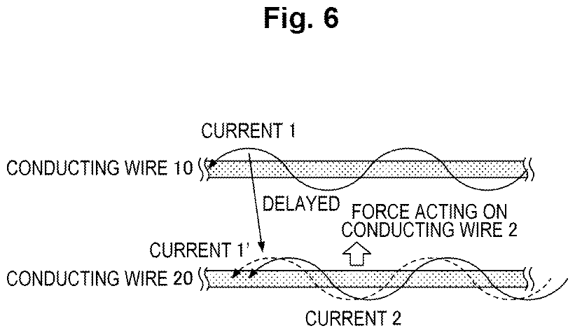

Next, a direction of a force acting on the conducting wire 20 will be considered. A magnetic field generated by the current flowing through the conducting wire 10 has a time delay while propagating the distance between the conducting wires 10 and 20. Therefore, as illustrated in FIG. 6, a state in which directions of currents flowing through the two conducting wires become the same is achieved. When the currents flowing through the two conducting wires are in the same direction, the directions of the forces acting on the conducting wires are attracting directions. Therefore, an upward force is generated in the conducting wire 20 as illustrated in FIG. 6.

A sum of the forces acting on the conducting wires 10 and 20 is a force generated in the entire propulsion device 100 including the conducting wires 10 and 20. Since an upward force acts on both the conducting wires 10 and 20 by flowing the current as illustrated in FIG. 4, an upward force is generated as a whole.

That is, when a high-frequency current having a phase difference of 90 degrees is made to flow through two conducting wires fixed with an interval therebetween in the propulsion device 100, a propulsive force can be obtained with the high-frequency power without using a propellant and without interacting with the outside.

### (First Configuration Example of Propulsion Device 100)

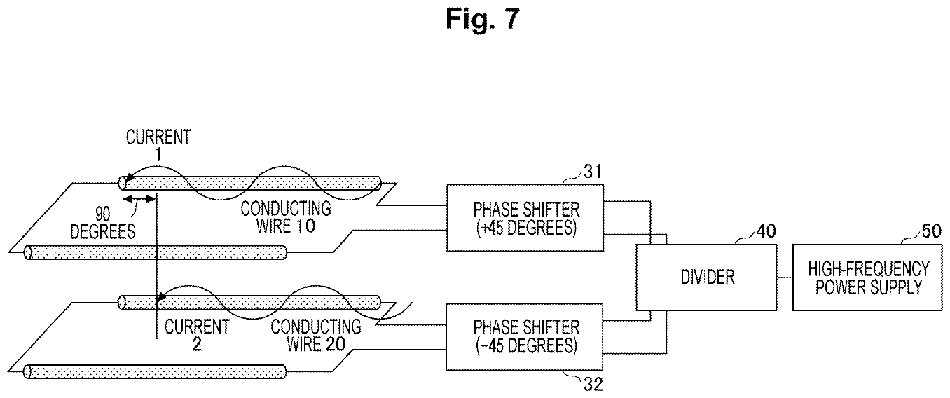

FIG. 7 illustrates a first configuration example of the propulsion device 100. As shown in FIG. 7, the propulsion device 100 according to the first configuration example includes a high-frequency power supply 50 that outputs a high-frequency current, a divider 40 that divides the output high-frequency current into two currents, phase shifters 31 and 32 that apply a phase difference to the two currents, and two conducting wires 10 and 20 that are fixed to the propulsion device 100 at regular intervals to obtain a propulsive force.

As illustrated in FIG. 7, in the first configuration example, the phase shifters 31 and 32 apply a phase difference such that the phase of the current flowing through conducting wire 20 is delayed by 90 degrees with respect to the phase of the current flowing through conducting wire 10.

When the phase of the current flowing through the conducting wire 10 is advanced by 90 degrees with respect to the phase of the current flowing through the conducting wire 20, the force generated from the entire propulsion device 100 is in the opposite direction (downward) to the case of FIG. 7.

### (Second Configuration Example of Propulsion Device 100)

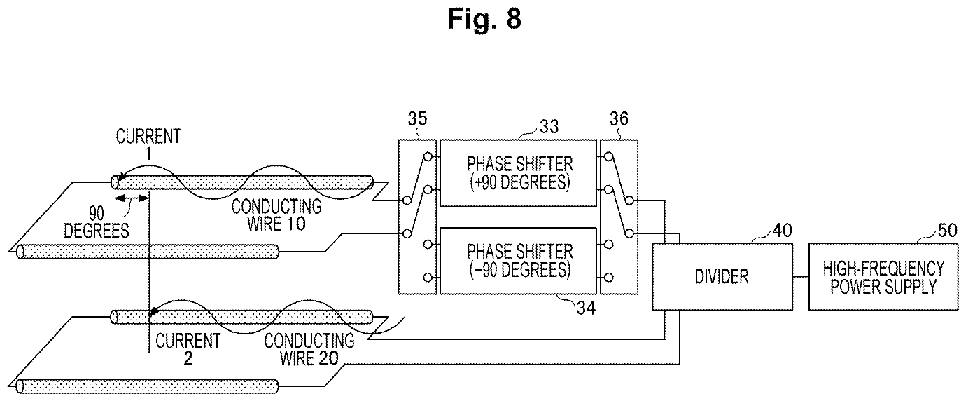

Accordingly, in the second configuration example, as illustrated in FIG. 8, two changeover switches 35 and 36 that switch the phase difference of the current flowing through the conducting wire 10 are included. The phase shifter 33 connected to the two changeover switches 35 and 36 advances the phase of the current by 90 degrees with respect to the conducting wire 20, and the phase shifter 34 delays the phase of the current by 90 degrees with respect to the conducting wire 20.

When the two changeover switches 35 and 36 are interlocked so that the phase of the current flowing through the conducting wire 20 is delayed by 90 degrees or advanced by 90 degrees with respect to the current flowing through the conducting wire 10, the direction of the propulsive force can be changed by switching the switches.

In the example of FIG. 8, two changeover switches 35 and 36 are provided on the conducting wire 10 side, but this is exemplary. The two changeover switches 35 and 36 may be provided on the conducting wire 20 side.

By changing the direction of the propulsion device 100 itself that has the configuration of FIG. 8 (or the directions of the conducting wires 10 and 20), it is possible to apply a propulsive force in any direction to the propulsion device 100.

### (Detailed Example of Conducting Wires)

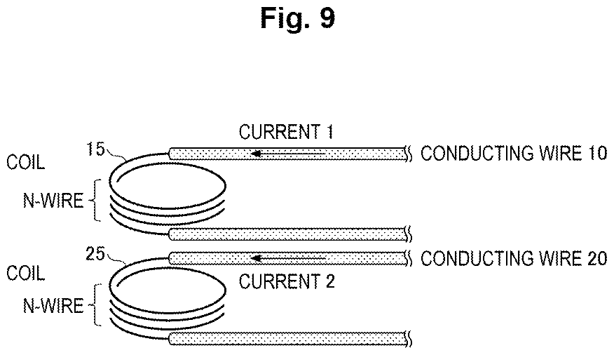

Detailed examples of the conducting wires 10 and 20 used in the first and second configuration examples will be described. The larger the currents flowing through the conducting wires 10 and 20 are, the larger the propulsive force to be generated is. Therefore, as illustrated in FIG. 9, in the present embodiment, the conducting wires 10 and 20 may each be bundled in a coil shape (N-wire coils 15 and 25 illustrated in FIG. 9). In this way, by bundling each of the conducting wires in a coil shape, a current flowing through the loop formed by the coil substantially increases. That is, in the case of the N-wire coil, magnitude of the current flowing through the loop is N times the current flowing through one conducting wire.

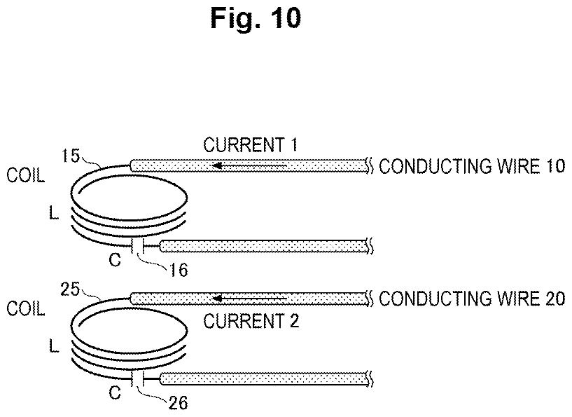

In the case of the high-frequency current used in the present embodiment, as illustrated in FIG. 10, when the capacitors 16 and 26 are installed such that inductance L of the coil and capacitance C of the capacitor resonate at a frequency f of the flowing current, a larger current can flow. At this time, a relationship of 2πf=1/√LC is satisfied.

### (Propulsive Force by Coil)

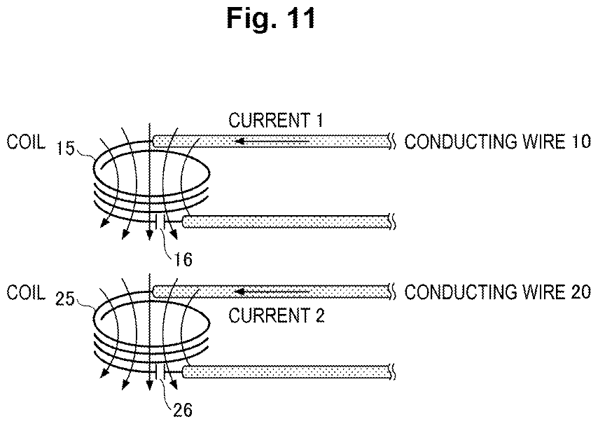

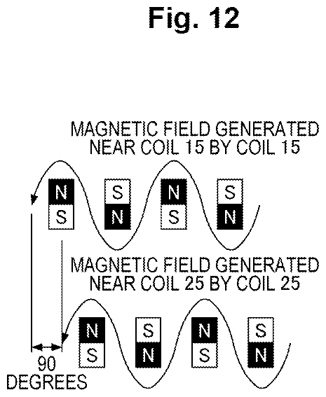

Here, the propulsion device 100 with this high-frequency current can be considered from another viewpoint. That is, as illustrated in FIGS. 11 and 12, when a current flows through the coils 15 and 25, a magnetic field is generated near the coils, and the coils repel or attract each other by the magnetic field. FIG. 12 illustrates a change in the magnetic field as an image of a magnet having N poles and S poles.

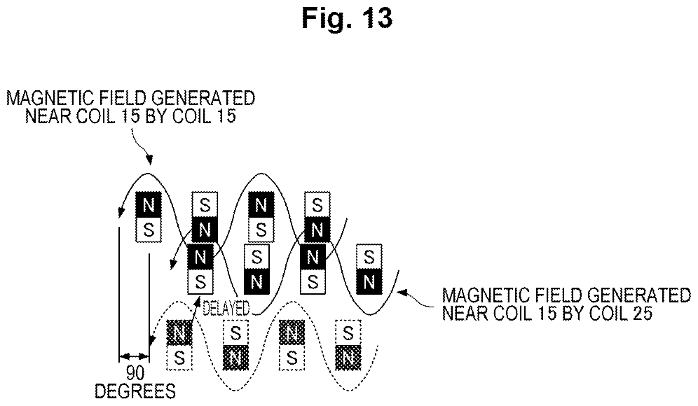

Here, in the configuration of FIG. 11, the direction of the force acting on the coil 15 is considered. The magnetic field generated by the coil 25 is delayed in time while propagating the distance between the coils 15 and 25. As illustrated in FIG. 13, the magnetic field generated by the two coils is in a state close to a state where the polarities of the magnetic fields are opposite. When the polarities of the magnetic fields generated by the two coils are opposite, the direction of the force acting on the coils is a direction of repulsion. Therefore, an upward force is generated in the coil 15.

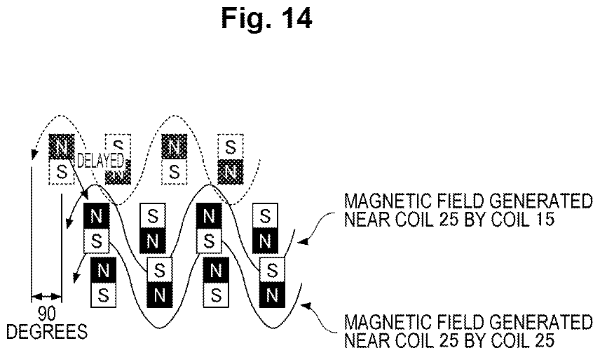

Next, a direction of the force acting on the coil 25 will be considered. The magnetic field generated by the coil 15 is delayed in time while propagating the distance between the coil 15 and the coil 25. As illustrated in FIG. 14, the magnetic field generated by the two coils enters a state close to a state where the polarities of the magnetic fields are in the same direction. When the polarities of the magnetic fields generated by the two coils are the same, the direction of the force acting on the coils is the attracting direction. Therefore, an upward force is generated in the coil 25.

A sum of the forces acting on the coils 15 and 25 is a force generated in the entire propulsion device 100 including the coils 15 and 25.

That is, when a high-frequency current having a phase difference of 90 degrees is made to flow through two coils fixed with an interval therebetween in the propulsion device 100, a propulsive force can be obtained with the high-frequency power without using the propellant and without interacting with the outside.

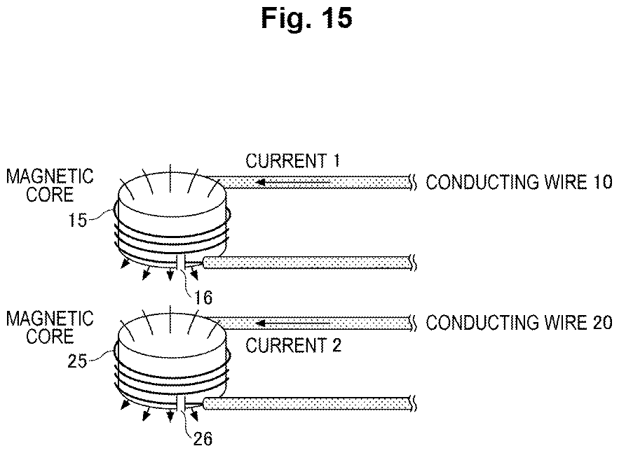

In order to increase a magnetic flux density, a magnetic core made of a magnetic material may be placed in the coil as illustrated in FIG. 15. As the magnetic material, a ferromagnetic material such as iron or nickel, ferrite with a small loss at high frequency, or the like is used. However, the magnetic material is not limited thereto.

### (Third Configuration Example of Propulsion Device 100)

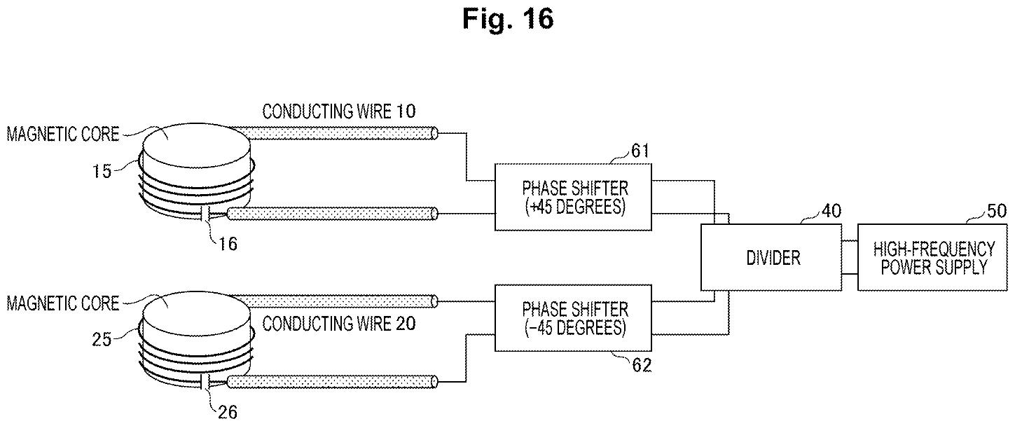

FIG. 16 illustrates a configuration of the propulsion device 100 using coils as a third configuration example of the propulsion device 100. As shown in FIG. 16, the propulsion device 100 according to the third configuration example includes the high-frequency power supply 50 that outputs a high-frequency current, the divider 40 that divides the output high-frequency current into two currents, phase shifters 61 and 62 that apply a phase difference to the two currents, and two coils 15 and 25 (conducting wires 10 and 20 having a structure with a coil shape) fixed at regular intervals to obtain a propulsive force. In the example of FIG. 16, a magnetic core is placed in the coil.

As described in FIGS. 13 and 14, the configuration illustrated in FIG. 16 can provide a propulsive force to the propulsion device 100.

### (Fourth Configuration Example of Propulsion Device)

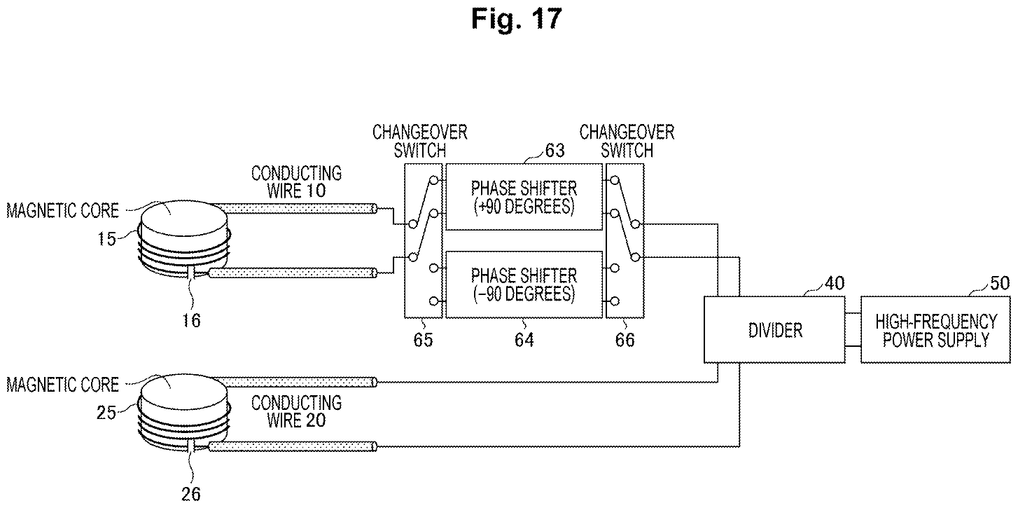

FIG. 17 illustrates a fourth configuration example of the propulsion device 100. As illustrated in FIG. 17, the propulsion device 100 includes changeover switches 65 and 66 that switch a phase difference between currents flowing through the two coils 15 and 25.

When the two changeover switches 65 and 66 are interlocked so that the phase of the current flowing through the conducting wire 20 is delayed by 90 degrees or advanced by 90 degrees with respect to the current flowing through the conducting wire 10, the direction of the propulsive force can be changed by switching the switches.

In the example of FIG. 17, two changeover switches 65 and 66 are provided on the conducting wire 10 side, but this is exemplary. Two changeover switches 65 and 66 may be provided on the conducting wire 20 side.

By changing the direction of the propulsion device 100 itself (or the directions of the coils 15 and 25) that has the configuration of FIG. 17, it is possible to apply a propulsive force in any direction to the propulsion device 100.

In each of the above-described configuration examples, the high-frequency current flowing through the conducting wires 10 and 20 is an example of an alternating current. An alternating current that has a frequency higher than a predetermined frequency may be referred to as a high-frequency current.

In each of the above-described configuration examples, a phase difference between the high-frequency currents (alternating currents) flowing through the conducting wires 10 and 20 is set to 90 degrees, but may not be strictly 90 degrees. For example, even when the phase difference deviates from 90 degrees within a range within a certain threshold, the phase difference may be regarded as “90 degrees”.

In each of the above-described configuration examples, the divider and the phase shifter are used to apply a phase difference to the alternating currents flowing through the conducting wires 10 and 20, but the use of the divider and the phase shifter is exemplary. Any means may be used as long as the phase difference can be given.

A size of an interval between the conducting wires 10 and 20 and a size of an interval between the coils 15 and 25 may be determined so that the phase relationships described in FIGS. 5, 6, 13, and 14 are realized according to the frequency of the alternating currents to be used.

### Effects of Embodiments

According to the technology according to the present embodiment, it is possible to implement a propulsion device that generates a propulsive force capable of performing acceleration, deceleration, and changing of a direction of a spacecraft with high-frequency power without using a propellant and without interacting with the outside.

Since no propellant is required, other loads can be accordingly loaded on the spacecraft, and a transport capacity of the spacecraft can be increased accordingly. If power can be secured using a solar cell or the like in space, acceleration, deceleration, and changing of a direction can be performed semi-permanently.

### (Supplementary Notes)

Disclosed herein are at least the following propulsion devices.

### (Clause 1)

A propulsion device including:
first and second conducting wires fixed with an interval therebetween; and
a power supply configured to output an alternating current,
wherein the alternating current output from the power supply having a phase difference of 90 degrees is made to flow through the first and second conducting wires.

### (Clause 2)

The propulsion device according to Clause 1, further including:
a divider configured to divide the alternating current output from the power supply into two currents; and
a phase shifter configured to apply the phase difference of 90 degrees between the two alternating currents divided by the divider.

### (Clause 3)

The propulsion device according to Clause 2, further including:
a changeover switch configured to advance a phase of the alternating current flowing through the first conducting wire by 90 degrees ahead of the phase of the alternating current flowing through the second conducting wire or delay the phase of the alternating current flowing through the first conducting wire by 90 degrees behind the phase of the alternating current flowing through the second conducting wire.

### (Clause 4)

The propulsion device according to any one of Clauses 1 to 3,
wherein the first and second conducting wires are each bundled in a coil shape.

### (Clause 5)

The propulsion device according to Clause 4,
wherein each of the first and second conducting wires includes a capacitor that performs LC resonance with inductance due to a structure with the coil shape at an output frequency of the power supply.

### (Clause 6)

The propulsion device according to Clause 4 or 5,
wherein each of the structure with the coil shape formed by the first conducting wire and the structure with the coil shape formed by the second conducting wire includes a magnetic core made of a magnetic material at a central axis.

While the present embodiment has been described above, the present invention is not limited to such a specific embodiment, and various modifications and changes can be made within the scope of the spirit of the present invention described in the claims.

### REFERENCE SIGNS LIST

100 Propulsion device
200 Spacecraft
1, 2 Current
10, 20 Conducting wire
15, 25 Coil
16, 26 Capacitor
31, 32, 33, 34, 61, 62, 63, 64 Phase shifter
35, 36, 65, 66 Changeover switch
40 Divider
50 High-frequency power supply

1. A propulsion apparatus comprising:
first and second conducting wires arranged with an interval therebetween; and
a power supply configured to output an alternating current,
wherein the alternating current output from the power supply having a phase difference of 90 degrees is made to flow through the first and second conducting wires.

2. The propulsion apparatus according to claim 1, further comprising:
a divider configured to divide the alternating current output from the power supply into two currents; and
a phase shifter configured to apply the phase difference of 90 degrees between the two alternating currents divided by the divider.

3. The propulsion apparatus according to claim 2, further comprising:
a changeover switch configured to advance a phase of the alternating current flowing through the first conducting wire by 90 degrees ahead of the phase of the alternating current flowing through the second conducting wire or delay the phase of the alternating current flowing through the first conducting wire by 90 degrees behind the phase of the alternating current flowing through the second conducting wire.

4. The propulsion apparatus according to claim 1,
wherein the first and second conducting wires are each bundled in a coil shape.

5. The propulsion apparatus according to claim 4,
wherein each of the first and second conducting wires includes a capacitor that performs LC resonance with inductance due to a structure with the coil shape at an output frequency of the power supply.

6. The propulsion apparatus according to claim 4,
wherein each of the structure with the coil shape formed by the first conducting wire and the structure with the coil shape formed by the second conducting wire includes a magnetic core made of a magnetic material at a central axis.
